(19) United States
(12) Patent Application Publication
(10) Pub. No.: US 2015/0294746 A1
(43) Pub. Date: Oct. 15, 2015

(54) FUEL POOL OF A NUCLEAR POWER PLANT

(71) Applicant: AREVA GmbH, Erlangen (DE)

(72) Inventors: Erhard MÜLLER, Pretzfeldt (DE); Marcus WORSCH, Baiersdorf (DE); Michael NEMECEK, Kleinsendelbach (DE); Norbert JAKOBS, Grossenseebach (DE)

(21) Appl. No.: 14/398,631

(22) PCT Filed: Apr. 8, 2013
(86) PCT No.: PCT/EP2013/057289

§ 371 Date: Nov. 3, 2014

(30) Foreign Application Priority Data
May 4, 2012 (DE) 10 2012 207 473.2

(51) Int. Cl. G21C 19/07

(52) U.S. Cl. CPC G21C 19/07

(57) ABSTRACT

Please replace the Abstract with the following replacement Abstract, which includes markings to show all changes relative to the previous version of the section in compliance with 37 C.F.R. §1.121(b)(2)(ii).

The invention relates to a nuclear power plant in which the sluice between a fuel pool and a reactor cavity is provided with a contractor, with which the sluice is automatically locked when the water level in the fuel pool falls under a predetermined threshold value.

The invention relates to a fuel pool of a nuclear power plant, said fuel pool being connected via a closeable sluice to a reactor pit arranged next to the fuel pool.

In a nuclear power plant, there is usually a flooded fuel pool next to the reactor pit in which spent fuel elements are stored in a fuel element storage rack and are cooled as a result of the circulation of the pool water contained in the fuel pool, until their activity has decayed to an extent such that they can be transported outside the fuel pool. A sluice is located between the reactor pit and fuel pool which can be closed by means of a lock gate and which can be opened during inspection work when the reactor pit is flooded, so that spent fuel elements taken from the core with the aid of the fuel element loading machine can be transferred under water from the reactor pit into the fuel pool and deposited in the fuel element storage rack.

In the event of a leakage occurring in the reactor pit, for example a pipeline break in a line feeding the reactor pit with water, or, in the case of a boiling water reactor, a leakage occurring in the flood compensator, the open sluice has to be closed in order to avoid a lowering of the water level in the fuel pool. The opening and closing of the lock gate are triggered manually.

As a lowering of the water level in the reactor pit is accompanied by a correspondingly higher radiation level on the floor of the pool in the event of a leakage, an alarm is triggered immediately as soon as such a leakage occurs, and the coworkers active at this moment on the floor of the pool have to leave the building immediately. Since the opening and closing of the lock gate are triggered manually, it may happen that the lock gate closing the sluice remains open. As a result of this, the water level in the fuel pool also falls at least as far as the lower edge of the sluice orifice. Consequently, there is a decrease in the amount of water covering the fuel elements stored in the fuel element storage rack, so that in the most adverse situation, upper parts of the fuel elements project above the water level and the radiation level becomes so great that the region in the surroundings of the fuel pool is no longer accessible and measures to cool the fuel elements can no longer be carried out or only with great difficulty.

It is an object of the invention to specify a fuel pool of a nuclear power plant with a sluice to a reactor pit, in which the aforementioned problems are avoided.

According to the invention, the object is achieved, by means of a fuel pool having the features of claim 1. According to these features, the sluice to the reactor pit is provided with a lock gate for automatically closing the sluice when the water level in the fuel pool falls below a predetermined limit value. This measure ensures that the fuel elements stored in the fuel pool are sufficiently covered with water even when the water level in the reactor pit falls below the predetermined limit value as a result of an accident.

Moreover, if a passive drive system with a network-independent energy storage is provided for driving the lock gate during automatic closure, closure of the sluice is ensured even in the event of a complete failure of the supply network in the nuclear power plant. Such a network-independent storage may be both an electrical and a mechanical energystorage, for example a raised weight or a pre-stressed spring, or a pneumatic energy storage which is coupled to the lock gate directly and without an electric drive.

A particularly high functional reliability can be achieved when the signal generator for the undershooting of the limit value and for triggering the closing movement of the lock gate comprises a float.

The invention is further illustrated with reference to the exemplary embodiments shown in the figures, wherein:

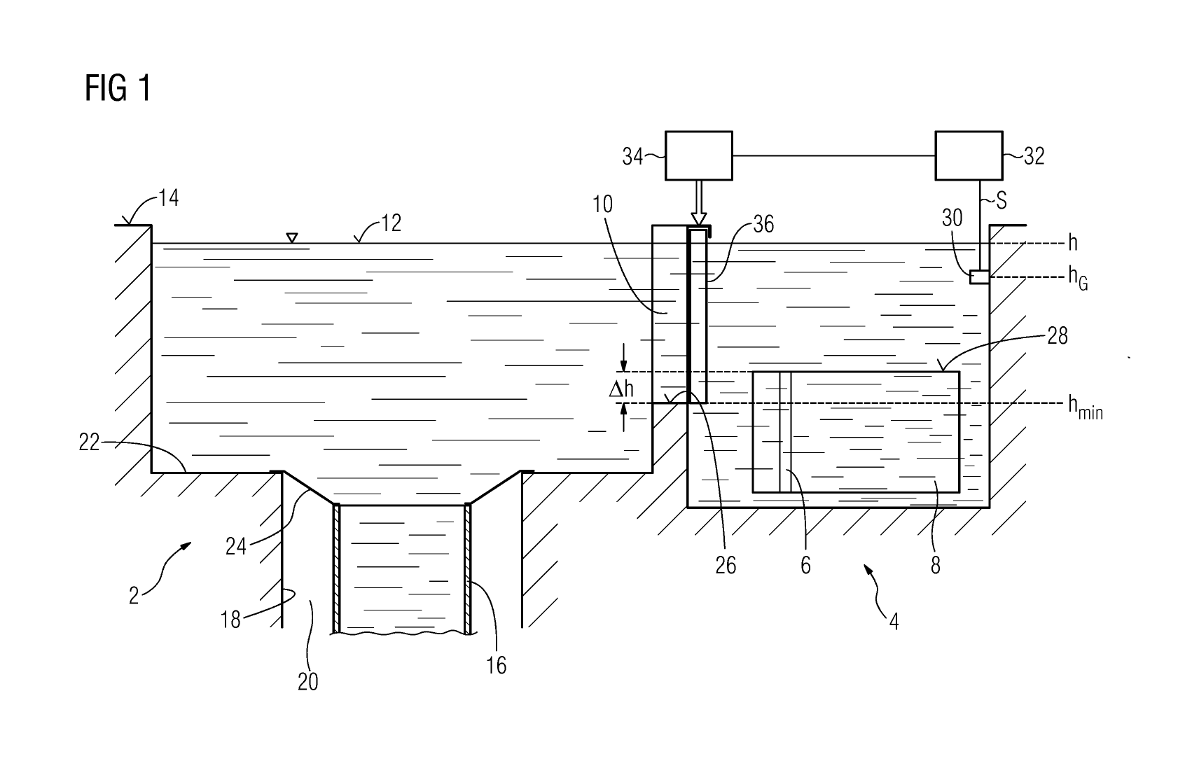

FIG. 1 shows a schematic representation of a fuel pool according to the invention, said fuel pool being arranged next to a reactor pit and being in fluid communication with the latter via a sluice;

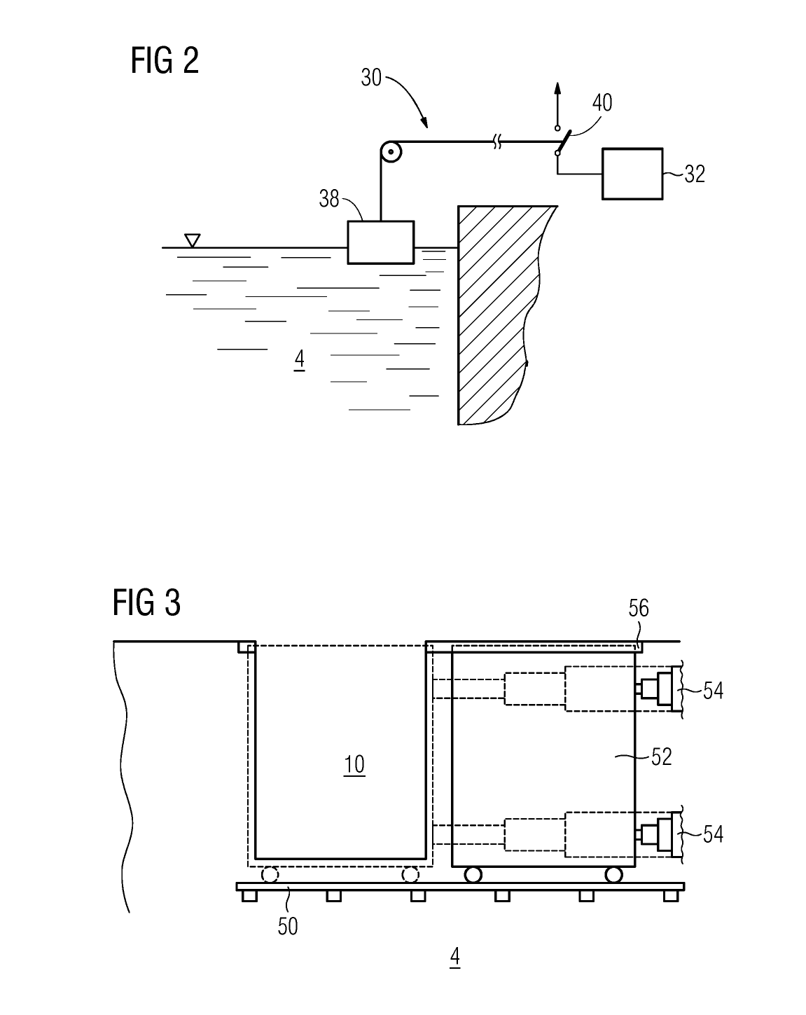

FIG. 2 shows a preferred embodiment in which the signal generator is arranged as a float;

FIGS. 3 to 6 show preferred embodiments of a lock gate suitable for automatically closing the sluice.

According to FIG. 1, a fuel pool 4 is located next to a reactor pit 2 of a nuclear power plant. Spent fuel elements 6, only one of which is illustrated symbolically, are stored upright in a fuel element storage rack 8 located in the fuel pool 4. The storage rack 8 is likewise illustrated only schematically. The reactor pit 2 and the fuel pool 4 are in fluid communication with each other via a closeable sluice 10. FIG. 1 illustrates a situation in which the reactor pit 2 is flooded with water, the water level 12, at a height h, being only slightly below the pool floor plane 14.

FIG. 1 shows a state of the nuclear power plant, as occurring during inspection work, for example during an exchange of fuel elements. A reactor pressure vessel 16 located in the reactor pit 4 is opened and is also flooded with water. In the exemplary embodiment illustrated, the situation in a boiling water reactor is shown, in which an interspace 20 located between the reactor pressure vessel 16 and the wall 18 of the reactor pit 2 is not flooded with water. In order to prevent the water from entering the interspace 20, so-called flood compensators 24 were introduced between the reactor pressure vessel 16 and the depositing surfaces 22 located next to it before the start of the inspection work.

It can be seen in FIG. 1 that the bottom 26 of the sluice 10 is located below the top edge 28 of the fuel elements 6 and the fuel element storage rack 8 in the exemplary embodiment illustrated. Accordingly, the fuel pool 4 would also be emptied as far as the level of this bottom 26 in the case of the reactor pit 2 running empty with the sluice 10 open, for example in the event of a breaking of a flood compulsator 24. In this case, the fuel elements 6 stored in the fuel element storage rack 8 would project by the amount Ah above the then established height hₘᵢₙ of the water level 12.

In order to avoid this, a signal generator 30 is arranged in the fuel pool 4 and generates a signal S when the height h of the water level 12 falls below a limit value h_{G}. With the aid of this signal S, a drive 34 is supplied with energy via a network-independent energy storage 32, for example a battery or a mechanical, pneumatical or hydraulic energystorage, that drives an opened lock gate 36, by means of which the sluice 10 is closed. In other words: when the water level 12 falls below a limit value h_{G}, the sluice 10 is closed automatically, that is to say without manual triggering being required, and passively, that is to say independently of a supply by an external network, so that a further lowering of the water level in the fuel pool is prevented and sufficient covering with water and cooling of the fuel elements 6 stored in the storage rack 8 is ensured.

In the exemplary embodiment according to FIG. 2, the signal generator 30 comprises a float 38 which actuates a switch 40, by means of which the energy storage 32 is connected to the drive 34.

In the exemplary embodiment of FIG. 3, a sluice 10 is illustrated, in which the lock gate 36 is formed by a plate 52 which is mounted on a horizontally extending rail 50 arranged on the wall of the fuel pool 2. The lock gate 52 can be alternatingly moved with the aid of hydraulic cylinders 54 between a position, in which the sluice 10 is opened, and a position, depicted by dashes, in which the sluice 10 is closed. A profile 56 that is also arranged on the wall of the fuel pool 2 serves as an upper guide for the lock gate 52, in order to ensure that the sluice 10 is closed reliably.

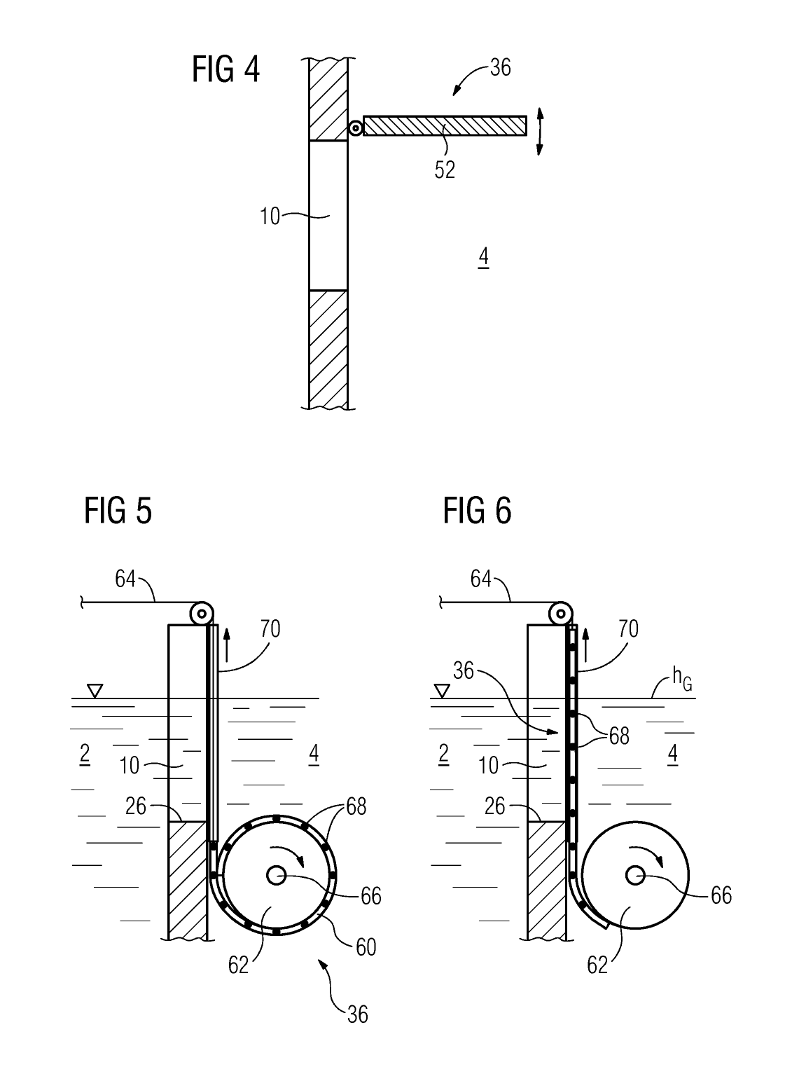

In an alternative embodiment illustrated in FIG. 4, the lock gate 36 is arranged as a pivotably mounted plate (pivoting lock gate) which closes the sluice 10 by means of a hydraulic, pneumatic or electric drive as a result of a pivoting movement.

Alternatively to the embodiments illustrated in FIGS. 3 and 4, wherein the lock gate 36 is essentially formed by a plate, a lock gate 36 of FIGS. 5 and 6 is provided in the form of a roller blind 60, which is wound on a roller 62 mounted below the bottom 26 of the sluice 10 and which can be unwound by means of a pull cord 64 in order to close the sluice 10. The roller blind 60 is composed of an elastic rubber-like membrane which is stiffened by profiles 68 which are arranged parallel to the axis of rotation 66 of the roller 62 and which, moreover, serve for guiding the roller blind 60 in guide rails 70 arranged next to the sluice 10.

Such a roller blind 60 may, for example, also be provided in addition to the displaceable lock gate illustrated in FIG. 3.

1. A fuel pool of a nuclear power plant, comprising a sluice to a reactor pit, said sluice being provided with a lock gate for automatically closing the sluice when the water level in the fuel pool falls below a predetermined limit value.

2. The fuel pool according to claim 1, wherein a passive drive system with a network-independent energy storage is provided for driving the lock gate during automatic closure.

3. The fuel pool according to claim 1, wherein a signal generator for the undershooting of the limit value and for triggering the closing movement of the lock gate comprises a float.

4. The fuel pool according to claim 2, wherein a signal generator for the undershooting of the limit value and for triggering the closing movement of the lock gate comprises a float.
